(19) United States
(12) Patent Application Publication
(10) Pub. No.: US 2005/0245381 A1
(43) Pub. Date: Nov. 3, 2005

(54) Centrifuge accelerator system

(75) Inventors: Ryllee Tab Tettleton, Spring, TX (US); Louis Charles Gouin, Spring, TX (US)

Correspondence Address: CONLEY ROSE, P.C., P. O. BOX 3267, HOUSTON, TX, 77253-3267, US

(73) Assignee: National-Oilwell, L.P., Houston, TX (US)

(21) Appl. No.: 10/836,024

(22) Filed: Apr. 30, 2004

(51) Int. Cl. B04B 1/20

(52) U.S. Cl. 494/53

(57) ABSTRACT

Provided herein are methods and apparatus for a centrifuge accelerator system releasably mounted within a centrifuge assembly by a detachable connector, thereby improving the accessibility of the accelerator. The centrifuge assembly includes a hollow bowl, a rotating conveyor, a drive shaft, and an accelerator. A series of detachable connectors are used to mount the drive shaft and accelerator within the centrifuge assembly, providing a repeatable technique for gaining access to the accelerator without damaging or destroying the rotating conveyor or drive shaft. Mounting the accelerator in a detachable, non-permanent manner renders the ability to repair or replace the accelerator more efficient.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

The embodiments of the present invention relate generally to systems for removing solids suspended in a liquid slurry. More particularly, the embodiments relate to systems for processing drilling fluids using a centrifuge.

One key component of a drilling rig is the drilling fluid circulation system or mud system, which circulates drilling fluid (mud) through the wellbore. The circulation system is also used to maintain the density of the drilling fluid by removing drilled cuttings from the fluid, and adding other solids to the fluid as may be desired. Among other drilling parameters, the density of the drilling fluid is critical to hole cleaning, rate of penetration, and pressure control in the well. Hole cleaning and rate of penetration are important factors in the efficiency of the drilling process, while pressure control is critical to safely drilling a well.

In general operation, drilling fluid is pumped by high-pressure pumps through the drill string and into the wellbore. The fluid exits the drill string at the bit and returns to the surface through the annulus between the drill string and the wellbore, carrying cuttings from the hole to the surface. The hydrostatic pressure created by the column of drilling fluid prevents fluids from the surrounding formation from entering the wellbore and potentially causing a loss of well control.

At the surface, the drilling fluid is then processed, in order to maintain the desired density, before it is pumped back through the drill string into the hole. Solids control equipment such as shakers, degassers, desilters, desanders, and centrifuges may be used to process the drilling fluid at the surface by removing solids and entrained gases from the fluid. Centrifuges are well known in the art for separating higher and lower density drilling fluid to permit the reuse of the drilling fluid.

One type of industrial centrifuge common in the drilling industry includes a rotating conveyor mounted concentrically within a rotating, cylindrical bowl. The conveyor typically incorporates helical blades on the outer surface and a hollow interior where the drilling fluid enters. As the drilling fluid enters the interior of the conveyor, it engages an accelerator mounted within the interior of the conveyor. The accelerator redirects the drilling fluid outward where it then exits the conveyor through one of the openings on the conveyor's outer surface. This process subjects the drilling fluid to the high centrifugal acceleration forces necessary to separate the varying densities of drilling fluid.

Because of the extremely abrasive nature of the drilling fluid and the high speed at which the centrifuge and its components rotate, the surfaces exposed to the drilling fluid are susceptible to wear and deterioration. Specifically, the accelerator may significantly wear, deteriorate, or become damaged over time such that it no longer provides the desired acceleration force to the drilling fluid. Many conventional centrifuges do not provide an economical or efficient means for accessing and replacing worn internal parts such as an accelerator. In such conventional centrifuges, the accelerator is usually permanently attached inside the conveyor by welding or an equivalent essentially permanent means. Thus, removal of the accelerator requires cutting and potentially destroying part of the conveyor.

Thus, it is desirable to have the ability to easily repair or replace a worn or deteriorated accelerator after the useful life of the part has expired. The embodiments of the present invention are directed to methods and apparatus for providing a centrifuge accelerator system that seeks to overcome certain limitations of the prior art.

### SUMMARY OF THE PREFERRED EMBODIMENTS

Provided herein are methods and apparatus for a centrifuge accelerator system releasably mounted within a centrifuge assembly by a detachable connector, thereby improving the accessibility of the accelerator. The centrifuge assembly includes a hollow bowl, a rotating conveyor, a drive shaft, and an accelerator. The conveyor is rotatably mounted concentric with the rotating bowl. A helical blade is positioned on the outer surface of the rotating conveyor. The interior of the rotating conveyor is substantially hollow and drilling fluid is pumped into the interior. A series of detachable connectors are used to mount the drive shaft and accelerator within the centrifuge assembly. The detachable connectors provide a repeatable technique for gaining access to the accelerator without damaging or destroying the rotating conveyor or drive shaft.

In one preferred embodiment, the drive shaft is releasably mounted to the rotating conveyor by a detachable drive shaft connector, and a first end of the drive shaft extends into the hollow interior of the rotating conveyor. The accelerator is positioned on the first end of the drive shaft within the rotating conveyor and mounted to the first end of the drive shaft by a detachable accelerator connector. The detachable drive shaft and accelerator connectors are preferably characterized by a plurality of evenly spaced, circumferentially positioned threaded bolts and securing nuts. The detachable, non-permanent connection of the drive shaft to the rotating conveyor allows the drive shaft and accelerator to be extracted from the rotating conveyor as a single, unitized assembly without localized destruction of the rotating conveyor. Similarly, the detachable, non-permanent connection of the accelerator to the drive shaft allows for removal of the accelerator from the drive shaft for the purpose of replacing the accelerator without damaging the rotating conveyor or drive shaft.

In another embodiment, the rotating conveyor is removed from the centrifuge assembly in order to provide access to the accelerator. The detachable drive shaft connector securing the rotating conveyor to the drive shaft is disengaged, freeing the rotating conveyor from the drive shaft and providing access to the accelerator. The detachable, non-permanent connection of the rotating conveyor to the drive shaft allows the rotating conveyor to be extracted from the centrifuge assembly, thereby providing access to the accelerator without localized destruction of the rotating conveyor.

In other embodiments, the detachable drive shaft connector for releasably mounting the drive shaft to the rotating conveyor is characterized by a plurality of evenly spaced, circumferentially positioned threaded lugs and securing lug nuts. Similarly, the detachable accelerator connector for releasably mounting the accelerator within the rotating conveyor to the first end of the drive shaft is characterized by a plurality of evenly spaced, circumferentially positioned threaded lugs and securing lug nuts.

Thus, the present invention comprises a combination of features and advantages that enable it to provide for an easily accessible and repairable centrifuge accelerator system. These and various other characteristics and advantages of the preferred embodiments will be readily apparent to those skilled in the art upon reading the following detailed description and by referring to the accompanying drawings.

### BRIEF DESCRIPTION OF THE DRAWINGS

For a more detailed understanding of the preferred embodiments, reference is made to the accompanying Figures, wherein:

FIG. 1 is a cross-sectional view of a centrifuge assembly constructed in accordance with embodiments of the invention;

FIG. 2 is an isometric exploded view of the centrifuge assembly of FIG. 1;

FIG. 3 is an isometric view of the drive shaft and accelerator of the centrifuge assembly of FIG. 1; and

FIG. 4 is an isometric exploded view of the drive shaft and accelerator of FIG. 3.

### DETAILED DESCRIPTION OF THE PREFERRED EMBODIMENTS

In the description that follows, like parts are marked throughout the specification and drawings with the same reference numerals, respectively. The drawing figures are not necessarily to scale. Certain features of the invention may be shown exaggerated in scale or in somewhat schematic form and some details of conventional elements may not be shown in the interest of clarity and conciseness. The present invention is susceptible to embodiments of different forms. There are shown in the drawings, and herein described in detail, specific embodiments of the present invention with the understanding that the present disclosure is to be considered an exemplification of the principles of the invention, and is not intended to limit the invention to that illustrated and described herein. It is to be fully recognized that the different teachings of the embodiments discussed below may be employed separately or in any suitable combination to produce the desired results.

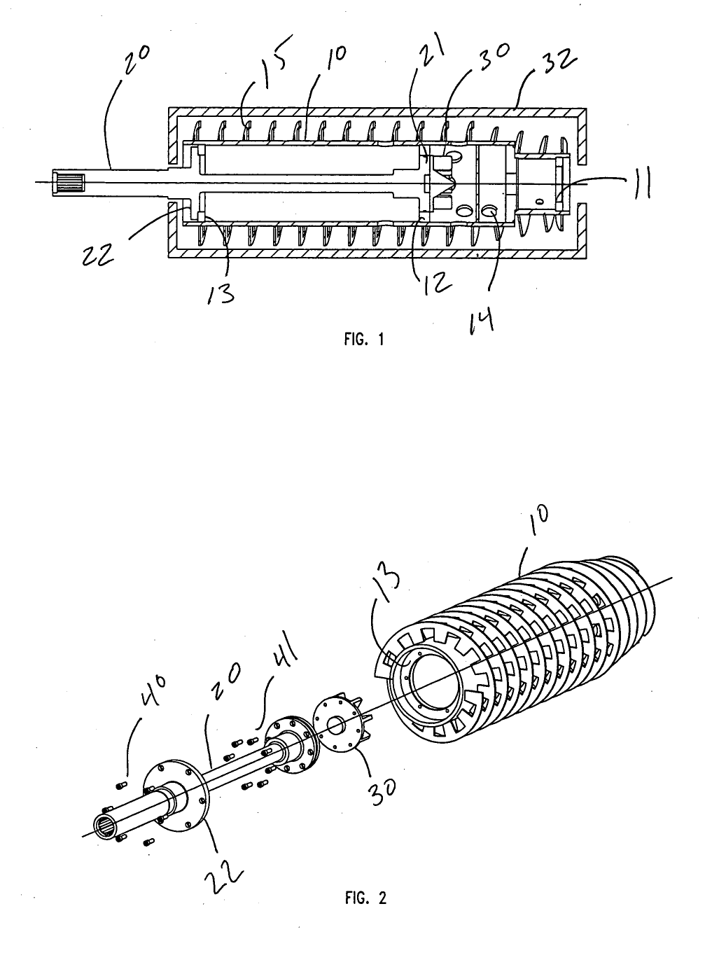

FIG. 1 shows a cross-sectional view of the centrifuge assembly including rotating conveyor 10, drive shaft 20, and accelerator 30 disposed in bowl 32. The components are shown as assembled during operation. First end 21 of drive shaft 20 is positioned within the hollow interior of rotating conveyor 10, and is supported around its circumference by interior flange 12. Accelerator 30 is located within the hollow interior of rotating conveyor 10 and attached to first end 21 of drive shaft 20. Second end 22 of drive shaft 20 rests flush against mounting flange 13.

Referring now to FIG. 2, an exploded view of conveyor 10, drive shaft 20, and accelerator 30 is shown. Drive shaft connector 40 and accelerator connector 41 connect drive shaft 20 to conveyor 13 and accelerator 30 to drive shaft 20, respectively. Connectors 40 and 41 may comprise a plurality of circumferentially located, equally spaced threaded bolts and securing nuts.

Drive shaft connector 40 releasably mounts second end 22 of drive shaft 20 to mounting flange 13 of rotating conveyor 10. Drive shaft connector 40 is disengaged to release drive shaft 20 and accelerator 30 from rotating conveyor 10. Once released, drive shaft 20 and accelerator 30 can be extracted from rotating conveyor 10 along the primary axis of the conveyor. Accelerator connector 41 mounts first end 21 of drive shaft 20 to accelerator 30. Accelerator connector 41 can be disengaged, such that accelerator 30 is released from drive shaft 20, once drive shaft 20 is removed from conveyor 10.

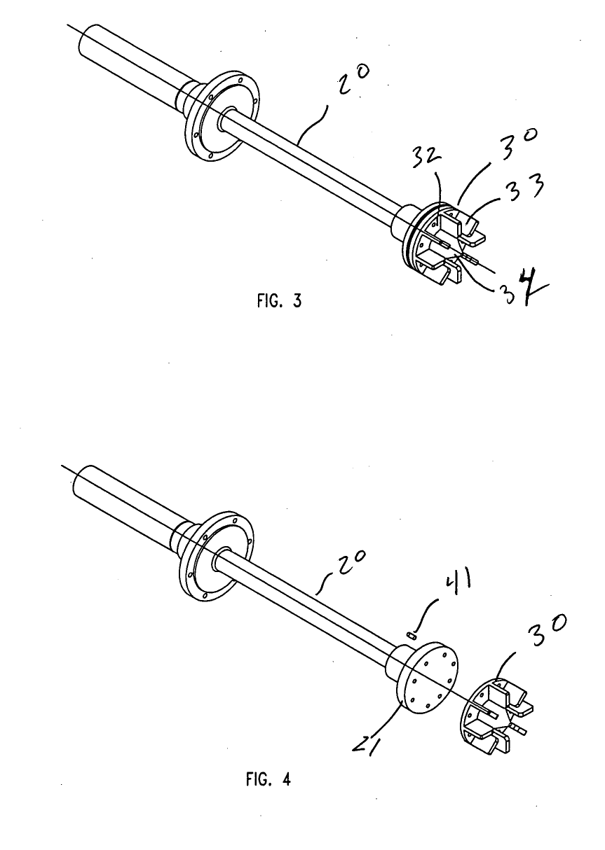

Referring now to FIGS. 3 and 4, drive shaft 20 and accelerator 30 are shown. FIG. 3 shows accelerator 30 assembled to drive shaft 20, forming the single unit that would be extracted from rotating conveyor 10. Accelerator 30 may be characterized by a plurality of directing vanes 33 oriented radially on the drilling fluid target surface 32. Target surface 32 may be a flat surface perpendicular to the axis of rotation of the centrifuge. Directing vanes 33 may be generally located at some radius less than the radius of accelerator 30 and terminate at the outer edge of accelerator 30. A generally cone-shaped form 34 with a radius less than accelerator 30 may be extruded axially from target surface 32.

FIG. 4 shows accelerator 30 removed from drive shaft 20. In one preferred embodiment, accelerator connector 41 is utilized to releasably mount accelerator 30 to first end 21 of drive shaft 20, and is comprised of a plurality of circumferentially located, equally spaced threaded bolts and securing nuts. Accelerator connector 41 is disengaged, releasing accelerator 30 from drive shaft 20. Accelerator connector 41 provides a repeatable, non-destructible method to remove accelerator 30 for repair or replacement.

Referring back to FIG. 1, during operation, drilling fluid enters the interior of rotating conveyor 10 through opening 11 and engages accelerator 30. The drilling fluid is accelerated and redirected radially after contacting accelerator 30. The accelerated fluid then exits rotating conveyor 10 through one of multiple apertures 14 in the surface of rotating conveyor 10.

The exiting fluid contacts bowl 32, which is rotated in the opposite direction of conveyor 10. The liquid and solid portions of the drilling fluid are separated by the rotational movement of conveyor 10 and bowl 32. Helical blade 15 moves the solid portion of the drilling fluid to a discharge point (not shown) at one end of bowl 32, while the liquid portion of the drilling fluid flows to a discharge point (not shown) on the opposite side of the bowl.

Because drilling fluid is often abrasive, repeated exposure to drilling fluid may cause accelerator 30 to wear and deteriorate. In one preferred embodiment, assembled drive shaft 20 and accelerator 30 can be extracted from rotating conveyor 10 as one unit. After assembled drive shaft 20 and accelerator 30 are extracted from rotating conveyor 10 as one unit, accelerator 30 can be removed from drive shaft 20 in order to replace or repair accelerator 30.

Upon completion of the repair or replacement of accelerator 30, detachable accelerator connector 41 is refastened to remount accelerator 30 to first end 21 of drive shaft 20. Assembled drive shaft 20 and accelerator 30 is reinstalled into rotating conveyor 10 along the centrifuge assembly's main axis of rotation. Second end 22 of drive shaft 20 is remounted to rotating conveyor 10 at mounting flange 13 by refastening detachable drive shaft connector 40, thereby returning assembled drive shaft 20 and accelerator 30 to its operating position.

In certain other embodiments, the drive shaft may be comprised of multiple connected sections that may provide for easier installation, handling, and component replacement. For example, the flange at first end 22 (see FIGS. 1 and 2) may be a two piece flange defining the connection point between two shorter shaft sections. The multiple sections may be interconnected by bolted flanges, or other connecting systems as may be appropriate.

The embodiments set forth herein are merely illustrative and do not limit the scope of the invention or the details therein. It will be appreciated that many other modifications and improvements to the disclosure herein may be made without departing from the scope of the invention or the inventive concepts herein disclosed. Because many varying and different embodiments may be made within the scope of the present inventive concept, including equivalent structures or materials hereafter thought of, and because many modifications may be made in the embodiments herein detailed in accordance with the descriptive requirements of the law, it is to be understood that the details herein are to be interpreted as illustrative and not in a limiting sense.

1. A centrifuge assembly comprising:
a rotating conveyor having a substantially hollow interior;
a drive shaft, releasably mounted to said rotating conveyor by a drive shaft connector, wherein said drive shaft has a first end that extends into the hollow interior of said rotating conveyor; and
an accelerator releasably attached to the first end of said drive shaft.

2. The centrifuge assembly of claim 1 wherein said drive shaft connector comprises a plurality of threaded bolts and securing nuts.

3. The centrifuge assembly of claim 1 wherein said accelerator is releasably attached to the first end of said drive shaft by an accelerator connector.

4. The centrifuge assembly of claim 3 wherein said accelerator connector comprises a plurality of threaded bolts and securing nuts.

5. A centrifuge assembly comprising:
a bowl operable to rotate about an axis;
a conveyor disposed within said bowl;
a drive shaft releasably connected to said conveyor and operable to rotate said conveyor about the axis in the direction opposite from the direction in which said bowl rotates;
a fluid inlet disposed on one end of said conveyor; and
an accelerator releasably connected to said drive shaft, wherein said accelerator is positioned within said conveyor such that fluid moving through said fluid inlet contacts said accelerator.

6. The centrifuge assembly of claim 5 further comprising a plurality of radial apertures through said conveyor, wherein said accelerator is operable to move fluid from inside said conveyor through said apertures to an annular region between said conveyor and said bowl.

7. The centrifuge assembly of claim 6 further comprising a helical blade disposed on said conveyor.

8. The centrifuge assembly of claim 5 further comprising a drive shaft connector releasably connecting said drive shaft to said conveyor.

9. The centrifuge assembly of claim 8 wherein said drive shaft connector comprises a plurality of threaded bolts and securing nuts.

10. The centrifuge assembly of claim 5 further comprising an accelerator shaft connector releasably connecting said accelerator to said conveyor.

11. The centrifuge assembly of claim 10 wherein said accelerator connector comprises a plurality of threaded bolts and securing nuts.

12. A method for gaining access to an accelerator in a centrifuge assembly, including a rotating conveyor, a drive shaft, and said accelerator, for repair or replacement of said accelerator, the method comprising the repeatable steps of:
(a) releasably mounting said drive shaft to said rotating conveyor by a detachable drive shaft connector, said drive shaft having a first end that extends into the hollow interior of said rotating conveyor;
(b) positioning said accelerator on the first end of said drive shaft;
(c) extracting said drive shaft and said accelerator from said rotating conveyor as one assembled system by releasing said detachable drive shaft connector; and
(d) reinserting said drive shaft and said accelerator into said rotating conveyor as one assembled system and mounting thereto by engaging said detachable drive shaft connector.

13. The method of claim 12 wherein said detachable drive shaft connector comprises a plurality of threaded bolts and securing nuts.

14. The method of claim 12 wherein said accelerator is releasably mounted to the first end of said drive shaft by a detachable accelerator connector.

15. The method of claim 14 wherein said detachable accelerator connector comprises a plurality of threaded bolts and securing nuts.

16. The method of claim 14 wherein said accelerator is removed from said drive shaft by releasing said detachable accelerator connector, and said accelerator is reinstalled on the first end of said drive shaft by engaging said detachable accelerator connector.

17. The method of claim 16 wherein said detachable accelerator connector comprises a plurality of threaded bolts and securing nuts.

18. The method of claim 16 further comprising repeating steps (a)-(d) to repair or replace the accelerator.

19. A method for gaining access to an accelerator in a centrifuge assembly, including a rotating conveyor, a drive shaft, and said accelerator, for repair or replacement of said accelerator, the method comprising the repeatable steps of:
(a) releasably mounting said drive shaft to said rotating conveyor by a detachable drive shaft connector, said drive shaft having a first end that extends into the hollow interior of said rotating conveyor;
(b) positioning said accelerator on the first end of said drive shaft;
(c) removing said rotating conveyor from said centrifuge assembly by releasing said detachable drive shaft connector;
(d) reinstalling said rotating conveyor within said centrifuge assembly and mounting therein by engaging said detachable drive shaft connector; and
(e) repeating steps (a)-(d) to repair or replace the accelerator.

20. The method of claim 19 wherein said detachable drive shaft connector comprises a plurality of threaded bolts and securing nuts.

21. The method of claim 19 wherein said accelerator is releasably mounted to the first end of said drive shaft by a detachable accelerator connector.

22. The method of claim 21 wherein said detachable accelerator connector comprises a plurality of threaded bolts and securing nuts.

23. The method of claim 19 wherein said accelerator is removed from said drive shaft by releasing said detachable accelerator connector, and said accelerator is reinstalled on the first end of said drive shaft by engaging said detachable accelerator connector.

24. The method of claim 19 wherein said detachable accelerator connector comprises a plurality of threaded bolts and securing nuts.
